(19) United States
(12) Patent Application Publication
(10) Pub. No.: US 2013/0001237 A1
(43) Pub. Date: Jan. 3, 2013

(54) Glass Container Having Sub-Surface Wall Decoration and Method of Manufacture

(76) Inventor: Dennis R. Marsh, Ottawa Hills, OH (US)

(21) Appl. No.: 13/172,080

(22) Filed: Jun. 29, 2011

(51) Int. Cl. B65D 1/40; B23K 26/00

(52) U.S. Cl. 220/660; 219/121.66

(57) ABSTRACT

A glass container has a multiplicity of three-dimensional discernible glass fracture patterns disposed between the inside and outside surfaces of the container wall. The fracture patterns preferably are disposed in a visually discernible non-random pattern, such as in the form of text, a logo, a decorative pattern or a combination thereof. The glass container wall thus decorated preferably is substantially stress-free.

The present disclosure is directed to formation of indicia in the wall of a hollow glass container.

### BACKGROUND AND SUMMARY OF THE DISCLOSURE

Decorative indicia, such as text, logos or design patterns, can be formed on an exterior surface of a hollow glass container during molding of the container, by chemical etching in a post-molding operation, or by other suitable post-molding operations. (The term “decoration” is employed in the broad sense to include ornamental and/or functional indicia.) One general object of the present disclosure is to provide a method of forming a visually discernible decoration within a wall of the container—i.e., between the inside and outside surfaces of the container wall—so that the decoration is part of the container and non-removable from the container. Another general object of the present disclosure is to provide a glass container having such wall decoration.

The present disclosure embodies a number of aspects that can be implemented separately from or in combination with each other.

A glass container in accordance with one aspect of the present disclosure has a wall of glass construction. A multiplicity of three-dimensional discernible glass microscopic fracture patterns or microcracks are disposed between inside and outside surfaces of the container wall. The microscopic fracture patterns preferably are disposed in a visually discernible non-random pattern, such as in the form of text, one or more logos, a decorative pattern or a combination thereof. The glass container wall thus decorated with microscopic fracture patterns preferably is substantially stress-free.

A method of decorating a glass container in accordance with another aspect of the present disclosure includes providing a glass container having at least one wall. A laser beam is directed onto the wall such that the beam is focused at a point between inside and outside surfaces of the container wall. Such focusing of the laser beam is continued for a time sufficient to cause microcracking in the container wall at the focus point. When the laser beam is terminated, the microcracking is discontinuous with the surrounding container wall and is visually discernible within the container wall. The glass container preferably is then annealed to reduce internal stresses in the container wall around the microcrack fracture pattern.

### BRIEF DESCRIPTION OF THE DRAWINGS

The disclosure, together with additional objects, features, advantages and aspects thereof, will best be understood from the following description, the appended claims and the accompanying drawings, in which:

FIG. 1 is an elevational view of a glass container decorated in accordance with an exemplary implementation of the present disclosure;

FIG. 2 is a functional block diagram that illustrates decoration of the container in accordance with an exemplary embodiment of the present disclosure;

FIG. 3 is a fragmentary sectional view of the portion of FIG. 2 within the area 3;

FIG. 4 is a fragmentary sectional view of the portion of FIG. 2 within the area 4;

FIG. 5 is a photomicrograph of a letter “O” formed in accordance with the present disclosure; and

FIG. 6 is a 55× enlargement of a portion of FIG. 5.

### DETAILED DESCRIPTION OF PREFERRED EMBODIMENTS

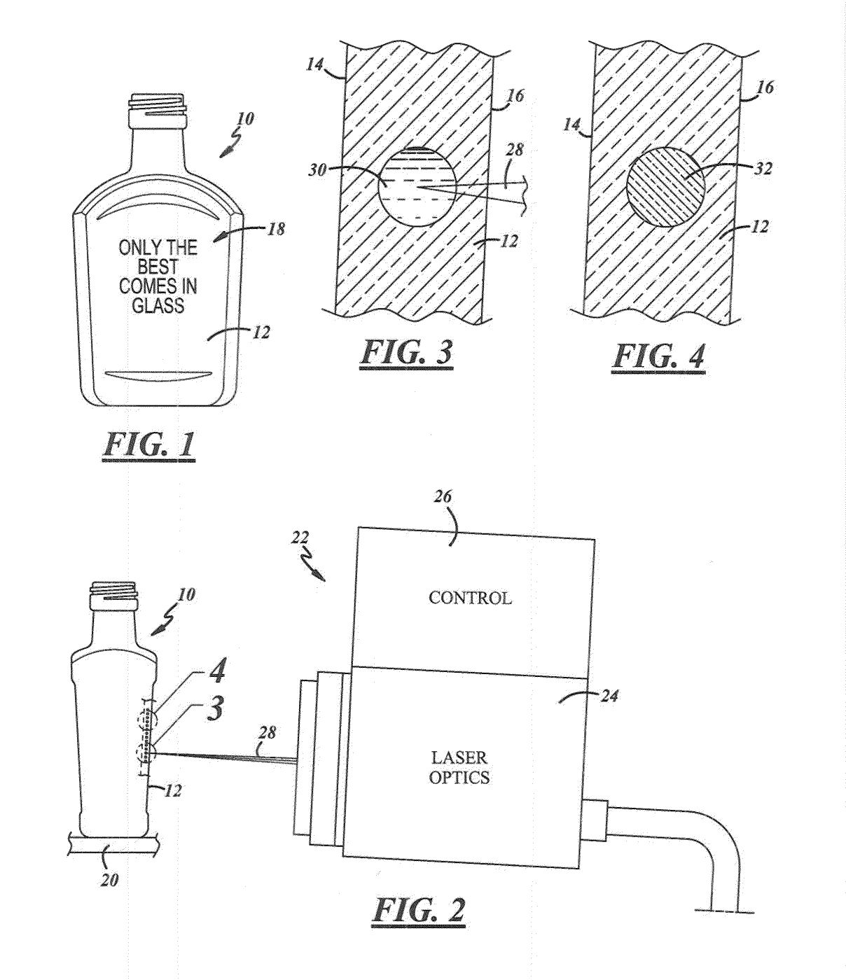

FIG. 1 illustrates a glass container 10 having a glass wall 12 surrounding a hollow interior. Container wall 12 has an inside surface 14 (FIGS. 3 and 4) and an outside surface 16. Container 10 and wall 12 are of glass construction and can be of any suitable glass composition. Wall 12 is a container sidewall in the example of FIG. 1, but could be any wall (or combination of walls) of the container, including the container bottom wall or base. A decoration 18 is formed at least in container wall 12 between inside and outside surfaces 14,16. Prior to decoration in accordance with the present disclosure, stress within the container preferably is reduced to a commercially acceptable level, typically greater than zero, such as by employing conventional annealing techniques.

FIG. 2 is a functional block diagram of an exemplary apparatus for implementation of the present disclosure. Container 10 is suitably presented, such as by a conveyor 20, at a decoration station 22. Laser optics 24 are disposed at station 22 and coupled to a laser optics control 26 to direct a laser beam 28 onto the exterior of container wall 12. Laser optics 24 and container wall 12 preferably are oriented at decoration station 22 such that the central axis of laser beam 28 is at a substantial angle, most preferably approaching a right angle, to the opposing outside surface of container wall 12. Conveyor 20 can be of any suitable type, such as a linear conveyor or a starwheel conveyor. Exemplary container 10 is a flask-shaped container, in which wall 12 is substantially flat (either flat or has a very large radius of curvature) when positioned opposite laser optics 24. When container 10 is cylindrical, for example, decoration station 22 could include suitable means for rotating the container, incrementally or continuously, so that the surface of wall 12 opposite laser optics 24 is substantially orthogonal to the axis of laser beam 28. The container wall(s) can be of any geometry.

With container 10 opposite laser optics 24, the laser optics are controlled by controller 26 to direct laser beam 28 onto the opposing container wall. Laser beam 28 is focused at a point between inside and outside surfaces 14,16 of container wall 12, as illustrated in FIG. 3. Laser beam 28 is continued for a time sufficient to form a microscopic inclusion 30 (FIG. 3). Laser beam 28 is then terminated (or focused at a new position), whereupon the portion of wall 12 surrounding inclusion 30 rapidly quenches the inclusion leaving a microscopic fracture pattern or microcrack 32 (FIGS. 4 and 6) in the container wall. Fracture pattern 32 is three-dimensional and of a microstructure that is discontinuous with (i.e., not a continuation of) the microstructure of the surrounding matrix of wall 12 so that fracture pattern 32 is visually discernible from outside of the container. Container wall 12 is thick enough, preferably but not necessarily at least three mm thickness, so that laser beam 28 can be focused within the container wall and not exit either inside surface 14 or outside surface 16. Fracture patterns 32 are completely contained within wail 12 and do not intersect either inside surface 14 or outside surface 16. Fracture patterns 32 preferably do not intersect each other.

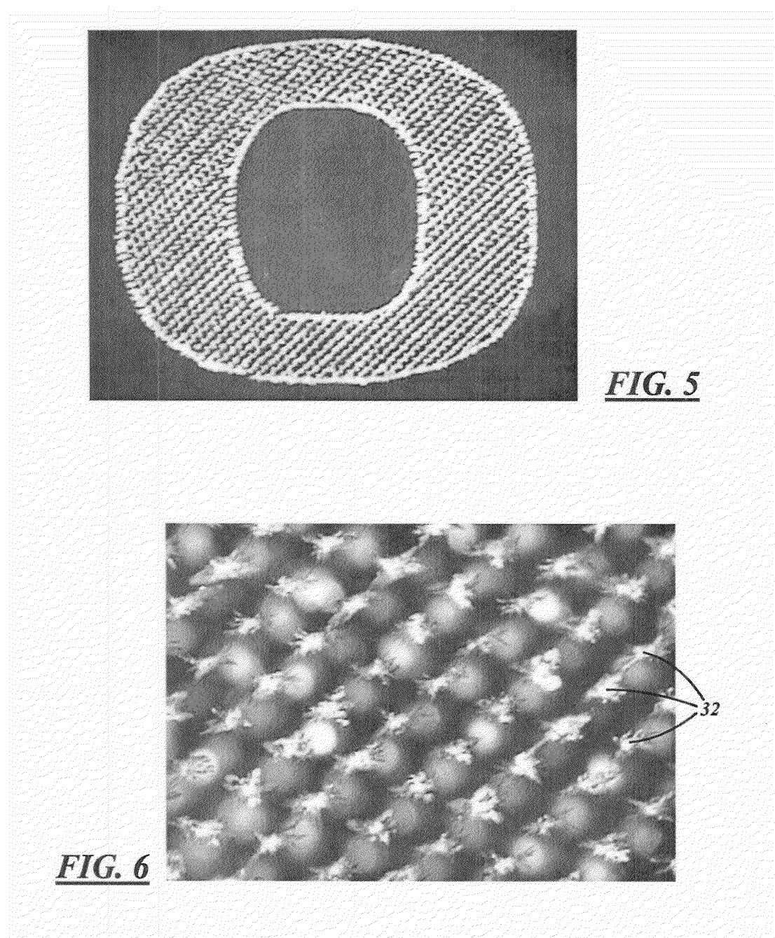

Decoration 18 (FIG. 1) is formed by redirecting laser beam 28 to different points within container wall 12 and/or by repositioning container 10 between illuminations. Conveyor 20 can be stationary or moving during and/or between laser shots. After repeated controlled illumination of container wall 12 with laser beam 28, the multiplicity of fracture patterns 32 form a non-random decoration 18, which can be in the form of text as illustrated in FIG. 1, one or more logos, a decorative pattern or a combination of these features. In applications where wall 12 is relatively thin, decoration 18 may be in a plane parallel to the wall outer surface. In applications where wall 12 is thicker, decoration 18 can be three-dimensional. FIG. 5 illustrates a letter “O” made in accordance with the present disclosure, and FIG. 6 illustrates a portion of FIG. 5 at 55×. Fracture patterns 32 appear as microscopic cracks in the glass wall.

After the decoration 18 is complete, container 10 preferably is annealed, such as by passing the container through an annealing lehr. This annealing operation removes substantially all of the internal container wall stresses caused by formations of fracture patterns 32, so that the container wall is substantially stress-free following the annealing operations. (The term “substantially stress free” means that any internal stresses in the glass are at or below commercially acceptable levels.) The container, or a group of containers, is heated to an annealing temperature at a rate that does not induce stress and breakage, held at annealing temperature(s) for a suitable time such as 20 to 60 minutes, and then cooled to room temperature at a rate that does not induce stress and breakage. This can be done by transporting the containers through a conventional annealing lehr.

By way of example only, laser beam 28 can have a pulse energy of 0.6 millijoules and a time duration of less than five nanoseconds for forming each fracture pattern 32. The total time required for forming decoration 18, that is the dwell time of container 10 at decoration station 22, can be on the order of three to five seconds. Container 10 can be of conventional soda-lime-silica composition.

There thus have been disclosed a glass container and a method of manufacture that fully satisfy all of the objects and aims previously set forth. The disclosure has been presented in conjunction with an exemplary embodiment, and additional modifications and variations have been discussed. Other modifications and variations readily will suggest themselves to persons of ordinary skill in the art in view of the foregoing discussion. The disclosure is intended to embrace all such modifications and variations as fall within the spirit and broad scope of the appended claims.

1. A glass container having a wall and a hollow interior, said container wall being of glass construction and having a multiplicity of three-dimensional discernible glass fracture patterns between inside and outside surfaces of said wall.

2. The container set forth in claim 1 wherein said wall, including said fracture patterns, is substantially stress-free.

3. The container set forth in claim 1 wherein said fracture patterns are disposed in a visually discernible non-random pattern between said inside and outside surfaces of said wall.

4. A glass container having a wall and a hollow interior, said container wall being of glass construction of a first microstructure and having a multiplicity of three-dimensional visually discernible glass fracture patterns of a second microstructure discontinuous with said first microstructure and entirely disposed between inside and outside surfaces of said wall.

5. The container set forth in claim 4 wherein said fracture patterns are formed as microscopic cracks within glass of said first microstructure.

6. The container set forth in claim 4 wherein said fracture patterns are disposed in a visually discernible non-random pattern between said inside and outside surfaces of said wall.

7. The container set forth in claim 6 wherein said wall, including said fracture patterns, is substantially stress-free.

8. A method of decorating a glass container that includes the steps of:
(a) providing a glass container having at least one wall,
(b) directing a laser beam onto the container wall such that said beam is focused at a point between inside and outside surfaces of the container wall,
(c) continuing said step (b) for a time sufficient to cause microcracking in the container wall at said point, and
(d) annealing said container to reduce internal stresses in said wall around the microcracking formed in said step (c).

9. The method set forth in claim 8 wherein said steps (b) and (c) are repeated by focusing said laser beam at different points in the container wall, said step (d) being carried out after the repeated steps (b) and (c) are completed.

10. The method set forth in claim 9 wherein, following said step (d), the microcracking formed in said repeated steps (b) and (c) is in a discernible non-random pattern.

11. The method set forth in claim 10 wherein said steps (b) and (c) are such that the microcracking formed in said step (c) is contained entirely between inside and outside surfaces of the container wall and does not intersect said surfaces.
